(19) United States
(12) Patent Application Publication
(10) Pub. No.: US 2013/0044385 A1
(43) Pub. Date: Feb. 21, 2013

(54) METHOD AND APPARATUS FOR IMAGE PLANE EXIT PUPIL CHARACTERIZATION

(71) Applicant: Brent J. Bos, Laurel, MD (US)

(72) Inventor: Brent J. Bos, Laurel, MD (US)

(73) Assignees: and Space Administration, Washington, DC (US); United States of America as represented by the Administrator of the National Aeronautics

(21) Appl. No.: 13/211,526

(22) Filed: Aug. 17, 2011

(51) Int. Cl. G02B 7/00

(52) U.S. Cl. 359/894

(57) ABSTRACT

An aperture mask for image plane exit pupil characterization of an imaging system is disclosed. The aperture mask includes a substantially opaque sheet configured to block portions of a wavefront travelling through an optical path of the imaging system, the sheet includes a plurality of holes, wherein the holes are positioned relative to each other such that a hole-to-hole distance generates a unique spatial frequency signature in the imaging system's point spread function.

### BACKGROUND

1. Field

The aspects of the present disclosure relate generally to the field of imaging systems and specifically to characterization of an imaging system's exit pupil.

2. Description of Related Art

Imaging system exit pupil characteristics are typically difficult and expensive to measure directly. In most cases the exit pupil in an optical system is a virtual image of the system's aperture stop and requires additional powered optical elements such as lenses and curved mirrors in the optical path to facilitate its observation and characterization. In the past, measurements of a system's exit pupil have typically not been performed due to complexity of the measurement. Recently the use of image-based, wavefront sensing algorithms to measure and improve an imaging system's performance has become more widespread. These wavefront sensing algorithms require knowledge of an optical system's exit pupil shape and illumination uniformity to develop accurate estimates of the wavefront generated by an optical system, forcing the use of expensive and complicated optical components for exit pupil characterization.

One of the key optical parameters of interest for an optical system is the system's exit pupil. An optical system's exit pupil is the image of the system's aperture stop as viewed from its image plane. The size, shape, and illumination characteristics of the exit pupil, affect and limits the spatial frequency content that can be detected at the image plane. It determines the image quality.

If an aperture stop is placed in an optical system such that no other optical elements come between the aperture stop and the image plane, then the aperture stop and the exit pupil are one in the same and its characterization is straightforward using mechanical measurement techniques. But for most imaging systems, the aperture stops are located at intermediate locations within the optical paths. When intervening optical surfaces are located between an aperture stop and a system's image plane, those intervening optics affect the exit pupil characteristics and eliminate the possibility of directly measuring the exit pupil through mechanical means.

On NASA's James Webb Space Telescope (JWST) project, image-based, wavefront sensing will be used to remotely “construct” JWST on-orbit characteristics and correct its performance. One of the JWST science instruments, the NIRCam (Near Infrared Camera), will be the primary wavefront sensing instrument. To determine the on-orbit exit pupil characteristics of NIRCam, the JWST Project will implement a pupil imaging capability within NIRCam by putting a set of lenses into a mechanism that swings into the optical path and generates an image of the NIRCam exit pupil onto the NIRCam detector when an image of the NIRCam exit pupil is desired. This capability has been difficult and costly to incorporate. The pupil imaging system consists of four moveable lenses that can be inserted into the optical path and cost more than $5 million in materials and manpower to implement. Unfortunately the image provided by the pupil imaging system is not a perfect representation of the NIRCam exit pupil since the pupil imaging system, due to its presence in the optical path, changes the NIRCam exit pupil image. Thus there is a need for a method and apparatus that can characterize the exit pupil without affecting the exit pupil image.

Because the pupil imaging system affects the optical path and therefore distorts the exit pupil image, it is necessary to characterize this distortion of the exit pupil image while the NIRCam is on the ground. To perform this characterization of the NIRCam pupil imaging system there is a need to have a way to directly measure the NIRCam exit pupil without using the pupil imaging system.

Accordingly, it would be desirable to provide a method or device that addresses at least some of the problems identified above.

### SUMMARY OF THE INVENTION

As described herein, the exemplary embodiments overcome one or more of the above or other disadvantages known in the art.

One aspect of the exemplary embodiments relates to an aperture mask for image plane exit pupil characterization in an imaging system. In one embodiment the aperture mask includes a substantially opaque sheet configured to block portions of a wavefront travelling through an optical path of the imaging system. The sheet includes a plurality of holes, wherein the holes are positioned relative to each other such that a hole-to-hole distance generates a unique spatial frequency signature in the imaging system's point spread function.

Another aspect of the exemplary embodiments relates to a method for characterizing an exit pupil of an imaging system. In one embodiment the method includes introducing an aperture mask into an optical path of the imaging system, wherein the aperture mask includes a plurality of holes, injecting light into the imaging system, collecting an image of an exit pupil of the imaging system using the detector. The image contains a point spread function and spatial frequency signatures contained in the image are analyzed to determine characteristics of the exit pupil.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the drawings:

FIG. 1 illustrates a schematic representation of the NIRCam optics.

FIG. 2 illustrates an exemplary 2-hole aperture mask incorporating aspects of the present disclosure.

FIG. 3 illustrates five different Pont Spread Functions generated by an exemplary 2-hole aperture mask incorporating aspects of the present disclosure with an increasing hole-to-hole separation.

FIG. 4 illustrates exemplary embodiments of unique and non-unique aperture mask designs incorporating aspects of the present disclosure.

FIG. 5 illustrates an exemplary 5-hole aperture mask incorporating aspects of the present disclosure.

FIG. 6 illustrates the spatial frequency signatures generated by the exemplary 5-hole mask illustrated in FIG. 5.

FIG. 7 illustrates an exemplary 16-hole aperture mask incorporating aspects of the present disclosure.

FIG. 8 illustrates the two dimensional Modulation Transfer Function generated from the Point Spread Function created by the exemplary aperture mask illustrated in. FIG. 7.

FIG. 9 illustrates the hole-to-hole distances of the exemplary aperture mask illustrated in FIG. 7.

FIG. 10 shows a table of the hole-to-hole distances that can be used to determine the locations of each hole in the exemplary mask illustrated in FIG. 7.

FIG. 11 illustrates a flow chart of a method for determining exit pupil characteristics incorporating aspects of the present disclosure.

### DETAILED DESCRIPTION OF THE EXEMPLARY EMBODIMENTS OF THE DISCLOSURE

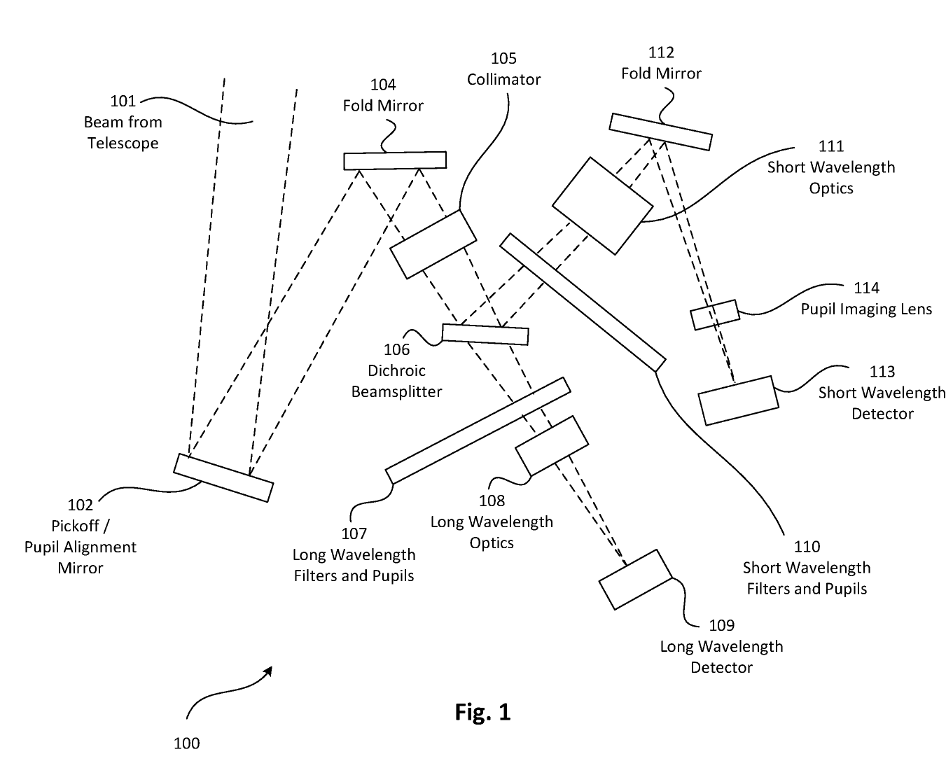

A recent trend in imaging systems, such as the NIRCam 100 in FIG. 1, is toward the use of image-based, wavefront sensing algorithms to measure and improve an imaging system's performance. This has led to the need for improved characterization of the exit pupil of an optical system, such as for example the NIRCam optical system 100 shown in FIG. 1. The current approach of characterizing the exit pupil through the use of additional powered optical elements such as lenses and curved mirrors in the optical path (for example the pupil imaging lens system 114) is not only expensive but, since the additional elements influence the characteristics of the optical system, characterization also becomes quite complex. Thus there is a need for a simple and low-cost method and apparatus for characterization of an optical system's exit pupil.

In describing the aspects of the disclosed embodiments, reference is made to the drawings, wherein there is seen in FIG. 1 an exemplary embodiment of the present disclosure showing a schematic layout of one of the two redundant modules for the Near Infrared Camera (NIRCam) used on the James Webb Space Telescope (MST). A schematic layout of one of these modules is shown generally as 100 in FIG. 1, where each module 100 contains a short (λ=0.7-2.3 μm) and a long (λ=2.4-5.0 μm) wavelength channel. The two channels in each module view the same field using a dichroic beam splitter 106. A pickoff mirror 102 is used to divert light from the telescope 101 into each module 100. Each channel has two filter wheels 107, 110 located at a pupil plane that contain a variety of wide-to-narrow bandpass filters, pupil imaging lenses and masks for wavefront sensing, and coronagraphic Lyot stops. An actuated pickoff mirror 102 at the NIRCam entrance provides proper alignment of the pupil image, compensating for any transverse mechanical misalignment between the camera and telescope. Refractive optics 105, 108, 111 in each channel are used to collimate the beam and to refocus them onto the detectors 109, 113. The detectors 109, 113 are placed at the focal plane of each channel and use Teledyne/Rockwell Scientific Hawaii-2RG HgCdTe 2048×2048 arrays with 18 μm pixels. In the short wavelength channel 113, they are arranged in a 2 by 2 mosaic covering a 2.2′ by 2.2′ field in each module with 0.032 arcsec/pixel. In the long wavelength channel 109, a single detector covers the same field size at 0.065 arcsec/pixel.

The Point Spread Function (PSF) of an optical system, such as for example optical system 100 in FIG. 1, is the response at the image plane, for example the detectors 109 and 113, of a focused optical system to a point source or point object. The PSF is a specific instance of the more general impulse response of an optical system. The Point Spread Function (PSF) is well known in the art and is theoretically described by the following equation:

$$PSF ( {x}^{′} , {y}^{′} ) = \frac{{I}_{0}^{2}}{{( λ f )}^{2}} {\vert [ {t}_{0} ( x , y ) {e}^{( \frac{t 2 nW ( x , y )}{λ} )} ] \vert}_{ξ = \frac{{x}^{′}}{λ f} , η = \frac{{y}^{′}}{λ f}}^{2} , \qquad ( Eq . 1 )$$

where x and y are positional coordinates in the exit pupil; x′ and y′ are positional coordinates in the image plane; ℑ represents the Fourier transform operation; ξ and η are the spatial frequencies in the Fourier transform domain; I₀ is the intensity of the incident wavefront; λ is the wavelength of the incident wavefront; f is the apparent distance from the exit pupil to the focal plane; t₀(x, y) is the amplitude transmission function in the exit pupil; and W(x, v) is the wavefront aberration in the exit pupil at wavelength λ.

The aspects of the disclosed embodiments determine the exit pupil amplitude function, t₀, by exploiting the exit pupil to image plane relationship governed by Eq. 1. To do this, an optical system's normal aperture stop mask, which is placed in the exit pupil, is replaced with a specially designed aperture mask that generates particular spatial frequency and pupil amplitude information in the PSF when light from a point source is introduced into the optical system. In the optical system 100 shown in FIG. 1, the expensive and complex pupil imaging lens system 114 could be replaced with a specially designed aperture masks.

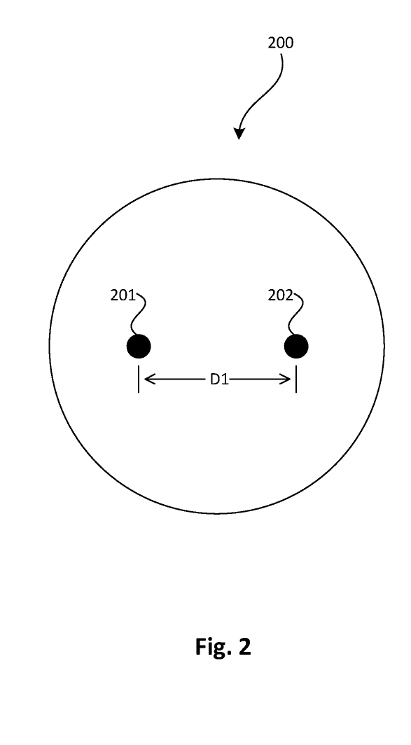

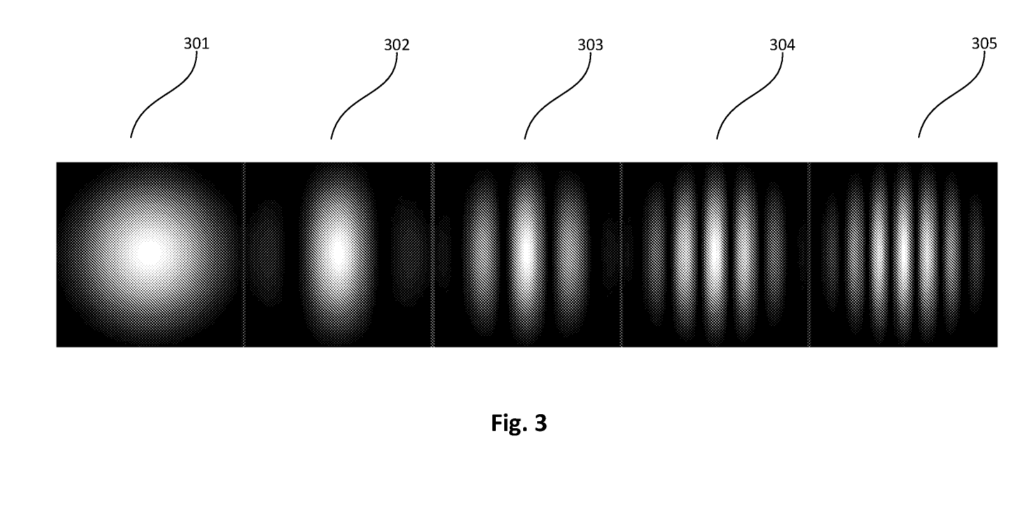

FIG. 2 illustrates a simple exemplary embodiment of an aperture mask 200 incorporating aspects of the present disclosure and designed to make use of the relationship described above. The aperture mask 200 in FIG. 2 is a mask with two small circular holes 201, 202, or openings through which light can pass, of equal diameter separated by a known distance, D1. Note that the term “light” as used herein is not limited to just the visible portion of the electromagnetic spectrum, it is intended to encompass the entire range of electromagnetic frequencies that may be observed by any general imaging system. The term light may include long waves through gamma waves. FIG. 3 shows the PSF (i.e. image of a point source of light) that is generated by the mask 200 with a series of increasing hole-to-hole distances, D1. The PSF on the extreme left 301, is generated by a two hole mask 200 with a hole-to-hole distance, D1, of zero (note that when D1 is zero, mask 200 reduces to a single hole mask) and is the classic PSF generated by an optical system with a circular aperture stop. FIG. 3 shows PSF's 301-305 generated by a two hole mask 200 with progressively larger hole-to-hole distance, D1, where PSF 305 corresponds to the largest distance D1. As hole-to-hole distance D1 is increased, a sinusoidal pattern begins to emerge consisting of a particular spatial frequency. Using Eq. 1 it can be shown that the spatial frequency, ν_{ab}, generated by such a mask is

$${v}_{ab} = \frac{Δ}{λ f} , \qquad ( Eq . 2 )$$

where Δ is the hole-to-hole distance, D1, between holes 201 and 202 in the exit pupil. In addition, the spatial frequency boundaries of the frequency signature caused by the diameter of the circular holes, 201 and 202, are located at

$${v}_{hole} = {v}_{ab} \pm \frac{d}{λ f} , \qquad ( Eq . 3 )$$

where d is the diameter of the hole in the exit pupil. After taking the Fourier transform of the PSF (i.e. calculating the modulation transfer function or MTF), the ν₀ and values calculated from the MTF can be used to determine Δ and d when λ and f are known. This provides for the determination of the exit pupil feature size and the aperture mask to exit pupil magnification. And when λ and f are not known, Δ and d can be solved in relative units “λf” which are useful for relative exit pupil scale determination.

Although a two-hole aperture mask 200 is useful for determining key exit pupil characteristics, constructing a mask that contains more holes allows more exit pupil information to be generated—most notably exit pupil distortion and exit pupil illumination uniformity. Circular holes were used in the above exemplary embodiment. However, in alternate embodiments, other shapes such as for example square, triangle, or other simple geometric shapes, may be preferable.

The design of a mask with more than two holes needs to be done with particular attention to Eq. 1 in order to obtain exit pupil information from the PSF it produces. Due to the Fourier transform operation in Eq. 1, the PSF does not maintain a one-to-one correspondence to positional information in the exit pupil amplitude transmission function, t₀(x, y). Based on the properties of Fourier transforms, it can be shown that if W(x, y) is small and can be assumed to be zero, then even for an exit pupil with asymmetry the Fourier transform will produce a real, even function.

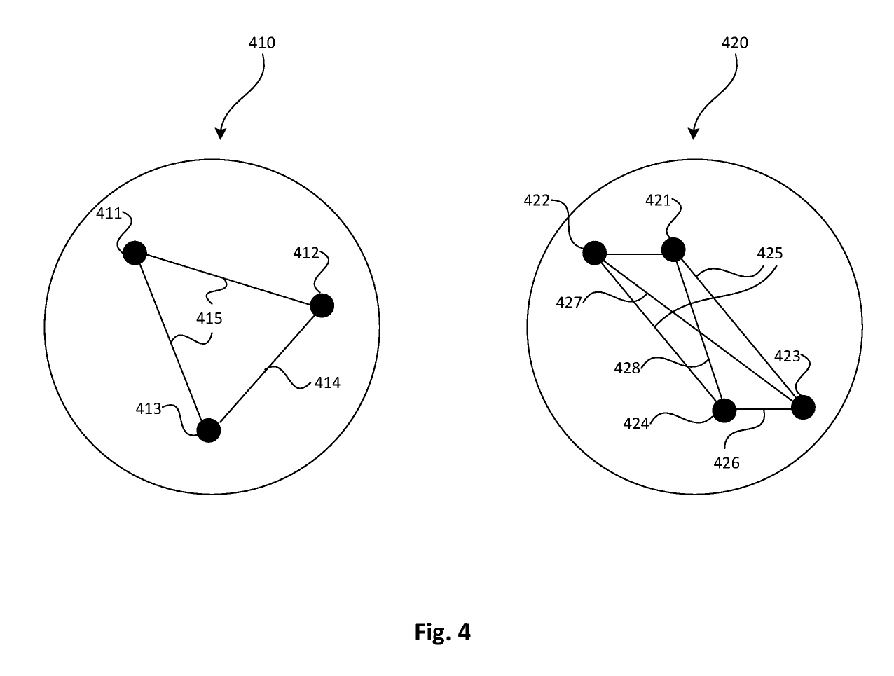

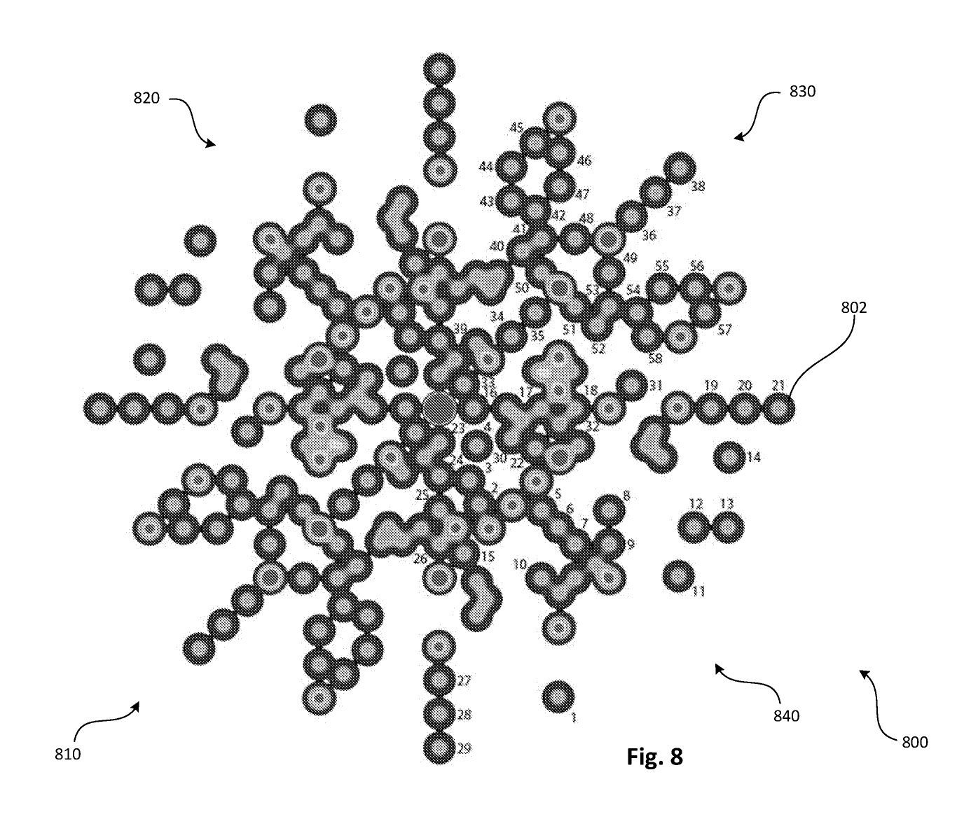

Referring to aperture mask 410 in FIG. 4, to maintain the transfer of positional information from a system's exit pupil to its PSF, aperture mask holes, 411, 412, 413 must be positioned relative to each other such that they generate unique spatial frequency signatures in the PSF. This can be done by spacing the holes such that no hole-to-hole distance, 413, 414, 415 is the same as any other and by arranging the holes such that their angular positions with respect to each other are unique. FIG. 2 shows two exemplary embodiments of the present disclosure that illustrate this point. The aperture mask on the left 410 is constructed with three holes, 413, 414, 415 consisting of two different hole-to-hole distances, 414, 415 (distances are shown as a solid line connecting the holes). Even though two of the hole-to-hole distances 415 are equal, the different angles that the two connecting lines make generate unique signatures in the PSF. The aperture mask on the right 420, however, is not unique. A not unique aperture mask, also called a degenerate aperture mask, is one where the hole-to-hole distances do not generate unique spatial frequency signals in the PSF. The aperture mask 420 is constructed from four holes 421, 422, 423, 424, and consists of six hole-to-hole distances 425, 426, 427, 428. Two sets of distances 425, 426 are equal and occur at the same angle therefore they will not generate unique spatial frequency signals in the PSF. It is also important to note that due to the even nature of the PSF (at least for those systems with small amounts of wavefront error, W(x, y)), unique angles only exist in two quadrants of the spatial frequency space and not the full 0° to 360° space. This can be seen in the spatial frequency signature 810 shown in FIG. 8 where each peak is reflected about the origin, as will be discussed in further detail below.

In order to design an aperture mask with more than two holes, additional relationships between the exit pupil, the PSF, and the Fourier transform of the PSF need to be considered. Eq. 4 shows how many non-zero spatial frequency signatures, N, are generated:

$$N = \frac{n ( n - 1 )}{2} , \qquad ( Eq . 4 )$$

with a given number of holes, n, in the aperture mask. The signal, Y, in PSF spatial frequency space (i.e. MTF space) of the unique spatial frequency component is:

$$Y = \frac{1}{n} , \qquad ( Eq . 5 )$$

when the light fluxes through each opening in the exit pupil are equal and the zero frequency component is normalized to one.

In addition, it is necessary to consider the pixel size and spacing of the optical system detector 109 or 113 that is going to be used to detect the PSF's generated by the aperture mask, such as for example aperture mask 200 in FIG. 2. The generation of spatial frequencies beyond the first zero in the spatial frequency response of the detector may not be detectable or may be aliased—jeopardizing the exit pupil characterization. So one guideline in determining the maximum apparent hole-to-hole distance in an exit pupil, Δₘₐₓ, that an aperture mask should generate is:

$${Δ}_{max} • \frac{λ f}{W} , \qquad ( Eq . 6 )$$

where W is the width of a detector pixel. In addition, the hole-to-hole distances must generate spatial frequency signatures that can be properly sampled per Nyquist sampling theorem. This means that the spatial sampling of the detector must be at least two times greater than the spatial frequency generated by the holes. So typically a more restrictive limit for Δₘₐₓ is

$${Δ}_{max} \leq \frac{λ f}{2 \sqrt{2} p} , \qquad ( Eq . 7 )$$

where p is the detector's pixel pitch. This ensures that even if there are spatial frequency features at a 45° angle with respect to the detector 109, 113, they will be detectable. Detectors such as for example detectors 109, 113, are typically aligned such that a 45 angle results in the greatest pixel pitch which corresponds to the smallest spatial sampling frequency. Eq. 7 may be able to be violated for certain mask designs but it is a useful, constructive rule of thumb in most applications. And it is often beneficial to choose hole-to-hole distances that are significantly less than the cut-off specified by Eq. 7 to account for as-built issues that typically arise with optical systems.

The exemplary aperture masks 200 in FIGS. 2 and 410, 420 in FIG. 4 are illustrated as having round or circular shaped holes. However, in alternate embodiments, circle is not the only hole shape that may be used for aperture mask holes, and any suitable geometric shape may be used. Circular holes are the most appropriate shape for aperture mask holes in a general purpose mask. A general purpose mask is one that is intended to characterize pupil dimensions with equal accuracy in all directions. Circular holes in the mask lead to circular frequency signatures making it easy to locate the geometric center with numerical techniques. However, in alternate embodiments, it is desired to have higher pupil dimension accuracy in one direction, so an elliptical or rectangular hole is used. The minor axes of the ellipses or rectangles would be aligned so that they are parallel to the direction in which the most accuracy is desired in the mask, and in general the narrow dimension would be as narrow as practical to make production of the mask feasible and to allow enough light through the system to obtain a useful image. Rectangular or elliptical holes can be used when the optical system is “light starved” (i.e. there is insufficient light) such that the system cannot record a PSF with enough signal using a reasonably sized circular hole. In that situation it is sometimes necessary to give up accuracy in one of the pupil directions. In a light starved situation the minor-axis of the ellipse or rectangle is aligned with the direction where most accuracy is desired and is made small enough to obtain the desired accuracy, while the other dimension is allowed to grow to a size that provides enough light to produce a useful signal.

When designing a mask with circular holes, the diameter of the holes is another important design consideration. Generally making the holes as small as possible is desired. For that case, the radiometry of the optical system is what determines the smallest acceptable diameter for a circular hole. As was noted above, the amount of light required to generate a useful signal is another consideration. Once the diameter is selected, the decision can be made regarding the smallest spatial frequency signature that an aperture mask, such as 200 in FIG. 2, should generate. Theoretically this could be as close to zero as physically possible, which would be:

Δₘᵢₙ=d, (Eq. 8)

where Δₘᵢₙ is the smallest hole-to-hole gap in the exit pupil. To make the data analysis task easier and the results less susceptible to noise, Eq. 9 is a better guideline

Δₘᵢₙ≧2d. (Eq. 9)

If Δₘᵢₙ=2d , then there will be no overlap between the zero spatial frequency function (see Eq. 3) and the spatial frequency function generated by the two holes separated by Δₘᵢₙ, making the data analysis straightforward even in the presence of noise.

As mentioned earlier, if a mask is constructed of more than two holes, the spatial frequency information embedded in the PSF can be used to determine the relative exit pupil illumination profile. The peak normalized signals, Y_{l,m}, in PSF spatial frequency space (i.e. MTF space) of the unique spatial frequency signatures are

$${Y}_{l , m} = \frac{{I}_{l} {I}_{m}}{{\sum }_{q = 1 , 2 …}^{n} {I}_{q}} , \qquad ( Eq . 10 )$$

where Iₗ is the relative electric field amplitude at hole l. Light irradiance or illumination is proportional to the square of electric field amplitude. This is a more general version of Eq. 5. The peak values of the spatial frequency signatures can be used to determine the relative light throughput at each hole. For an exemplary mask, 410 in FIG. 4, containing three holes the relationship is

$${I}_{1} = \sqrt{\frac{{Y}_{1 , 2} {Y}_{1 , 3}}{{Y}_{2 , 3}}} . \qquad ( Eq . 11 )$$

The equation for the relative intensities of the other holes, 413, 414 in the exemplary mask 410 can be generated by replacement of corresponding subscripts. For an exemplary aperture mask 420 including four holes, the PSF contains redundant pupil intensity information shown by

$${I}_{1} = \sqrt{\frac{{Y}_{1 , 2} {Y}_{1 , 3}}{{Y}_{2 , 3}}} = \sqrt{\frac{{Y}_{1 , 2} {Y}_{1 , 4}}{{Y}_{2 , 4}}} = \sqrt{\frac{{Y}_{1 , 3} {Y}_{1 , 4}}{{Y}_{3 , 4}}} . \qquad ( Eq . 12 )$$

And the redundant relative pupil intensity information increases as holes are added to the aperture mask.

Using the design process described above, or variations thereof, it is possible to design a wide variety of aperture masks, such as for example aperture masks 200, 410, 420, or 700, for exit pupil characterization. The guiding principle for positioning holes in the aperture masks is to arrange them such that the spatial frequency signatures, also referred to as peaks, in the PSF generated by the mask can be unambiguously linked to a particular hole combination. This unambiguous linkage will be described in more detail below. Merit-function-based algorithms can be used to do the designs automatically using mathematical implementations of that principle.

For the most restrictive type of aperture mask, the design rule is that along any slope in the aperture mask a particular hole-to-hole distance should only be used once. This type of mask is a non-degenerate mask and generates spatial frequency information that is very easy to analyze. Unfortunately though, due to the reality of Eq. 4, the PSF spatial frequency space fills up very quickly given that the hole distances along a particular slope need to fall within the boundaries specified by Δₘᵢₙ and Δₘₐₓ. At times this can limit the usefulness of the aperture mask due to the limited positions in the pupil that the aperture samples. In those cases a less restrictive version of the mask can be implemented. Such a mask allows for some degeneracy in the PSF spatial frequency space but still provides a unique, unambiguous path for determining hole-to-hole distances. An example of such a mask that is being used for MST's NIRCam will be discussed in more detail later.

The final key consideration in the design of the aperture mask of the disclosed embodiments is how closely the spatial frequency peaks should be positioned next to each other.

The data analysis is significantly simplified, and the peak intensity spatial frequency equations (Eqs. 5, 10-12) hold true if the center of each spatial frequency signature is ≧d/λf away from the center of each other spatial frequency signature. A more conservative rule of thumb that will make the pupil measurements more robust against as-built errors is to keep the center-to-center positions ≈2d/λf or more apart. Using Eqs. 1 and 2 we find that the holes in the mask should be placed such that their locations in the exit pupil are approximately 2d away from each other.

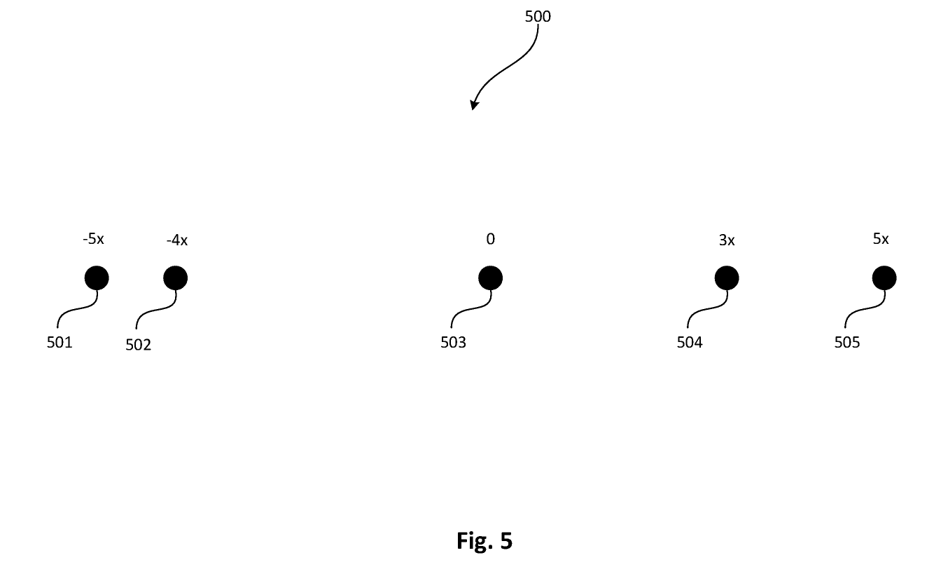

Referring to FIG. 5 an exemplary embodiment of an optimal aperture mask 500 incorporating aspects of the present disclosure is shown which contains a linear distribution of five holes 501, 502, 503, 504, 505, spaced at 0 x, +3 x, −4 x, +5 x, and −5 x. The value of scaling factor x is dependent on the imaging system being characterized such that

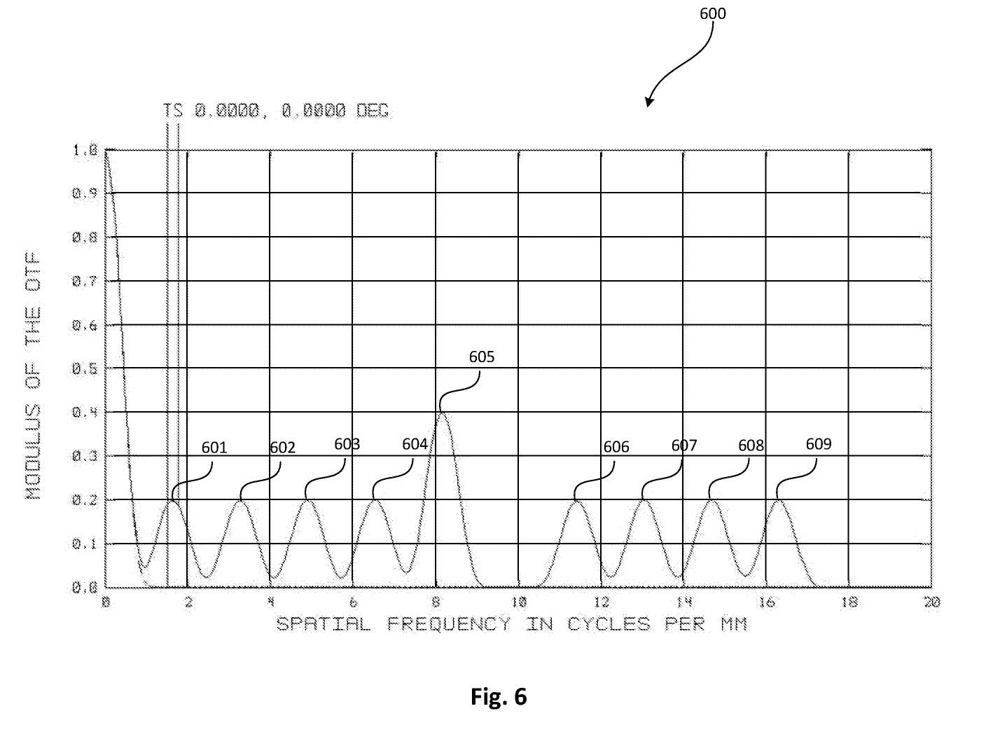

x=(ξₘₐₓλf)/10, (Eq. 13)

where ξₘₐₓ is the maximum spatial frequency allowed by the pixel pitch of the detector, such as for example detector 113. This frequency is determined using the Nyquist sampling theorem and must be less than half the spatial frequency defined by the pixel pitch of the detector 113. Designing aperture masks such as 500 in FIG. 5 with a scaling factor, x, allows the masks to be readily adapted for use in other imaging systems. For the NIRCam used in the JWST x=9.26624 mm (λ=1.87 μm, f=3040 mm). This generates 10 spatial frequencies, i.e. peaks, throughout the desired range at: 1/x, 1/2x, 1/3x, 1/4x, two at 1/5x, 1/7x, 1/8x, 1/9x, and 1/10x, where each spatial frequency corresponds to a particular hole-to-hole distance. The frequency and amplitude of each peak is used to characterize the distortion and illumination. An aperture mask, such as aperture mask 500, where all hole-to-hole distances are parallel, generates a MTF with all peaks on a single line. Such a MTF can be viewed as a two dimensional graph of amplitude versus frequency. An amplitude versus frequency graph of the MTF generated by aperture mask 500 is shown FIG. 6. The lowest frequency peak 601 is produced by the smallest hole-to-hole distance which is the distance between hole 501 and hole 502. Similarly the highest frequency peak 609 is produced by the largest hole-to-hole distance which is the distance between hole 501 and hole 505. Since two of the hole-to-hole distances, 501-to-503 and 503-to-505, are the same they both generate a peak at the same frequency, 1/5x, resulting in a peak 605 with greater amplitude. Whenever peaks in a MTF are at the same frequency or are so close in frequency that the peaks cannot be separated, an ambiguity occurs where the contributions from each hole-to-hole distance that generated them cannot be separated. Therefore the individual hole-to-hole distances cannot be calculated from the MTF. When a peak, such as any of peaks 601, 602, 603, 604, 606, 607, 608, and 609, can be attributed to a single hole-to-hole distance it is said to be unambiguous. An unambiguous peak is a peak that can be used to calculate the hole-to-hole distance from which it was generated.

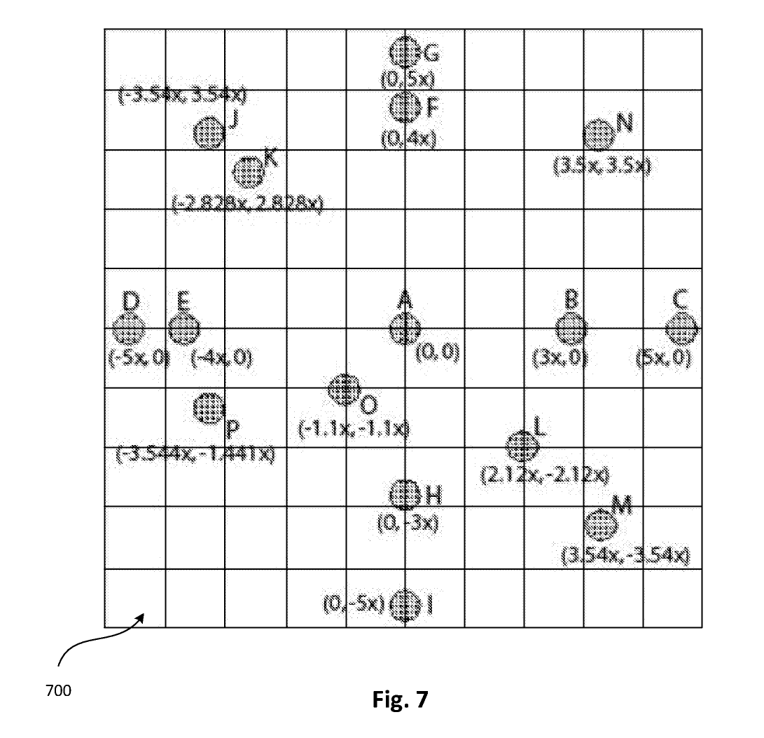

FIG. 7 illustrates one embodiment of a 16-hole aperture mask 700 incorporating aspects of the present disclosure. The 16-hole aperture mask 700 shown in FIG. 7 was designed for characterizing the exit pupil of the NIRCam illustrated in FIG. 1. The aperture mask 700 includes holes A through P, which are 5 millimeters (mm) diameter circular openings. Each hole, A through P, in aperture mask 700 has an ordered pair next to it representing each hole's relative coordinates along a horizontal and vertical axis. This mask has also been designed using a scaling factor so that the layout can be readily adapted for use in other imaging systems. The value of the scaling factor, represented as a multiplier x following some of the values in the ordered pairs, is set to x=9.266224 for the NIRCam short wave channel, which begins at pickoff mirror 102 and ends at detector 113 shown in FIG. 1. To make use of this mask layout for another system, adjust the value of x so that the affect at the system's exit pupil complies with the design considerations previously described and adjust the hole size based on the guidelines previously discussed, where keeping the holes as small as possible is generally preferred. The MTF 800 shown in FIG. 8 corresponds to the PSF generated by the exemplary 16-hole aperture mask 700 shown in FIG. 7.

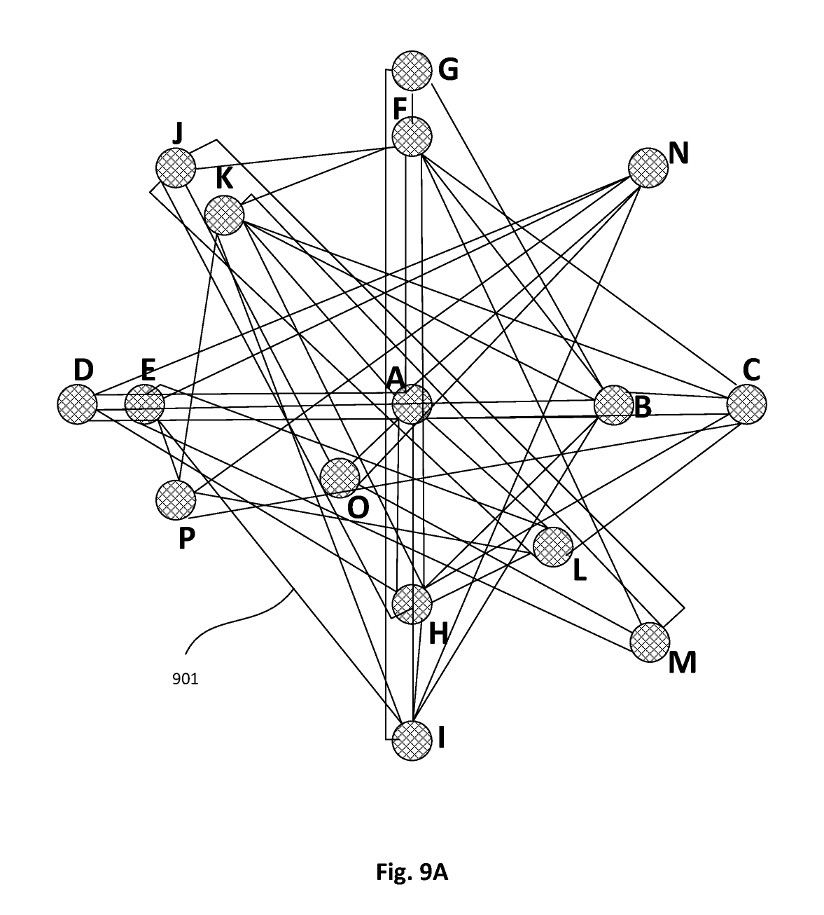

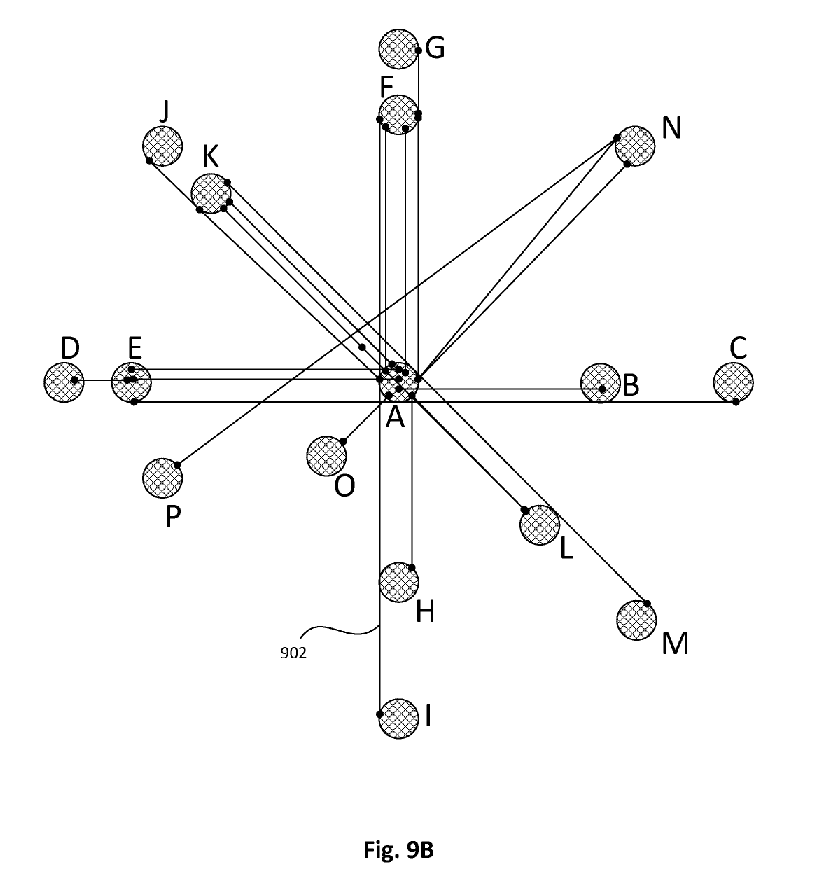

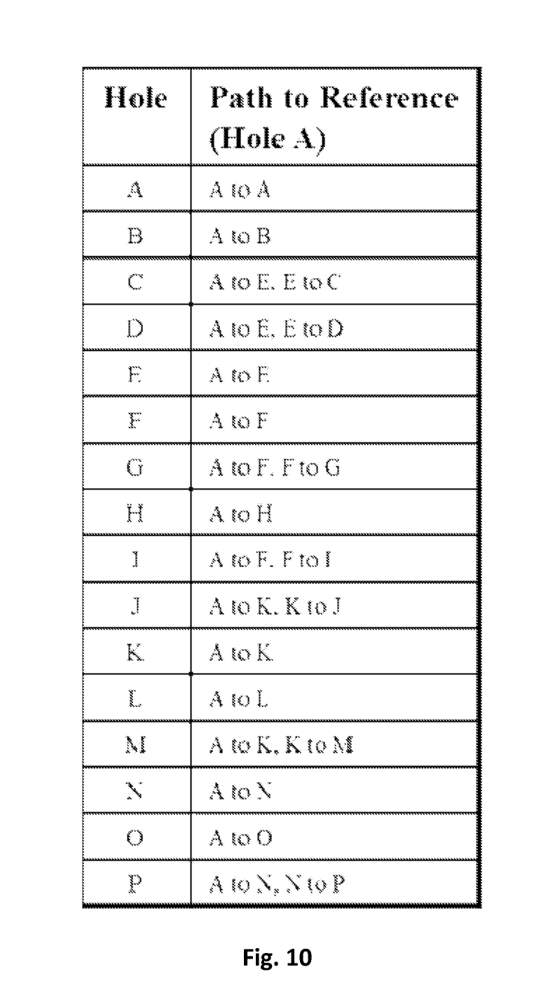

The aperture mask 700 shown in FIG. 7 is an example of an aperture mask that is degenerate but still generates spatial frequency signatures that can be used to unambiguously characterize the exit pupil. FIG. 8 shows the two dimensional MTF 800 corresponding to the PSF generated by the aperture mask 700. Each pair of holes in the aperture mask 700 generates a frequency signature or peak in the MTF. This relationship was discussed above using aperture mask 500 and the MTF in FIG. 6. Since hole-to-hole distances in the aperture mask 700 occur at different slopes the aperture mask 700 generates a two dimensional MTF 800 where each circle represents a peak. The lightly shaded circles numbered 1 through 58, one of which is indicated by 802, indicate spatial frequency signatures that are generated by an unambiguous hole-to-hole distance in the aperture mask 700. 58 unambiguous peaks have been identified and labeled 1 through 58, in the MTF 800 shown in FIG. 8. Unique spatial frequency information exists only in two quadrants of the MTF, the other two quadrants contain duplicate information, i.e. the information in quadrants 810 and 820 duplicate the information in quadrants 830 and 840. The lines 901 in FIG. 9A show the 58 hole-to-hole distances in the aperture mask 700 of FIG. 7 corresponding to the unique spatial frequency signatures labeled in the MTF 800 of FIG. 8. Of those 58 distances, only 22 are required for determining the location of each hole in the exit pupil, leaving 36 other signatures for measurement redundancy. The lines 902 in FIG. 9B show the minimum set of 22 distances necessary to determine the locations of holes A through P. The table FIG. 10 shows a summary of the 22 hole-to-hole distances that can be used to determine the location of each hole, A through P, in the aperture mask 700 of FIG. 7.

For NIRCam ground testing the beam 101 will be generated by an optical simulator that behaves as if it were the JWST. In one embodiment, aperture mask 700 is made out of a sheet of aluminum and will be inserted into the NIRCam optical path, shown in FIG. 1, at a pupil position in beam 101 in front of the pickoff mirror 102. Although the optical simulator can provide narrow-band illumination, during testing, an internal NIRCam filter 110 will be used to provide the necessary monochromatic illumination. The aperture mask 700 is mounted on a rotating pupil wheel so that it can be removed from the optical path 101 when the NIRCam exit pupil is not being tested. This rotating pupil can also be moved laterally with respect to the optical axis of the system. By moving the mask laterally in the optical path 101 and recording other images at each lateral position more than the 16 measurement points provided by aperture mask 700 can be produced.

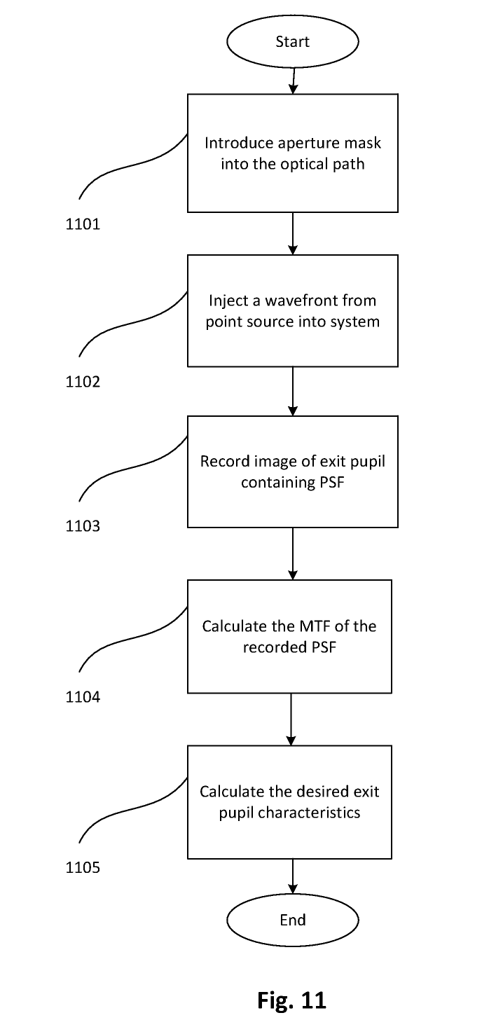

During ground testing of the NIRCam the exemplary aperture mask 700 will be used to determine two exit pupil characteristics: exit pupil distortion and relative exit pupil illumination. An exemplary embodiment of a method for determining these NIRCam exit pupil characteristics is illustrated by the flow chart in FIG. 11. In the first step 1101 in FIG. 11, an aperture mask containing a pattern of holes, as described above, is introduced into the optical path 101 of the NIRCam in front of the pickoff mirror 102 in FIG. 1. Next, at step 1102, a wavefront from a point source, beam 101, is injected into the system. An image of the exit pupil is recorded at step 1103 using the detector 113. The recorded image contains a PSF of the optical system under test. An MTF is then generated from the recorded image containing the PSF at step 1104. The MTF can then be analyzed, step 1105, to determine the desired exit pupil characteristics. Exit pupil distortion can be calculated by using Eq. 2 to calculate the relative distances between each exit pupil point sampled by the aperture mask. Relative illumination can be determined by analyzing the amplitudes of each frequency peak. Those skilled in the art will recognize that many other useful characteristics can also be determined from images recorded using an aperture mask as described herein. To take full advantage of the redundant positional information provided by aperture mask 700 and to speed up the analysis, an iterative algorithm can be used for the analysis that finds the hole-to-hole distances that best agree with the spatial frequency signatures, i.e. peaks, in a least squares sense. To determine the relative exit pupil illumination, measurements of the normalized spatial frequency component peaks can be used in Eq. 12.

Although the exemplary aperture mask described in FIG. 7 was designed for use with the NIRCam, it can also be used to test the exit pupils of the other JWST instruments or other imaging systems as desired. In some test setups there is only room for one of these aperture masks, however it is often possible to change the wavelength of the monochromatic light that is used. An inspection of Eqs. 2, 3, 6, and 7 shows how knowledge and manipulation of the wavelength of the light, λ, can be used to adjust the spatial frequencies that are generated.

As Eq. 1 shows, the PSF is not only affected by the exit pupil amplitude transmission function but by the wavefront aberration as well. The derivation of Eqs. 2-12 was done under the assumption that the system wavefront aberration, W(x, y), was small and could be set to zero. Unfortunately real optical systems, even high-performance ones, will suffer from some amount of wavefront error. The impact of wavefront error on the presently disclosed exit pupil measurement approach was investigated and it was found that spatial frequency signature peaks and positions are quite insensitive to wavefront aberration. The effects of coma astigmatism and spherical aberration were studied at levels more than twice as large as what was expected during the NIRCam testing and the impact appeared to be minimal.

The aspects of the present disclosure provide a simple low cost alternative for characterizing an imaging system's exit pupil by creating an aperture mask that allows exploitation of the relationship between the PSF and MTF shown in Eq. 1. Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit or scope of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An aperture mask for image plane exit pupil characterization in an imaging system, the aperture mask comprising:
a substantially opaque sheet configured to block portions of a wavefront travelling through an optical path of the imaging system, the sheet including a plurality of holes, wherein the holes are positioned relative to each other such that a hole-to-hole distance generates a unique spatial frequency signature in the imaging system's point spread function.

2. The aperture mask of claim 1 wherein a shape of each of the plurality of holes is circle, square, ellipse, rectangle, or a simple geometric shape.

3. The aperture mask of claim 2 wherein the shape is a circle.

4. The aperture mask of claim 3 wherein a smallest hole-to-hole distance is greater than or equal to twice a diameter of the holes.

5. The aperture mask of claim 3 wherein the plurality of holes comprises sixteen circular holes configured to produce fifty-eight unambiguous peaks in a frequency signature.

6. A method for characterizing an exit pupil of an imaging system, the imaging system including an aperture mask and a detector, the method comprising:
introducing an aperture mask into an optical path of the imaging system, wherein the aperture mask includes a plurality of holes:
injecting light into the imaging system;
collecting an image of an exit pupil of the imaging system using the detector, wherein the image contains a point spread function;
analyzing spatial frequency signatures contained in the image, to determine characteristics of the exit pupil.

7. The method according to claim 6 wherein the characteristics comprise distortion and relative illumination.

8. The method according to claim 6 wherein at least one peak in the spatial frequency signatures can be unambiguously linked to a hole-to-hole distance in the plurality of holes.

9. The method according to claim 6 wherein a shape of each of the plurality of holes is circle, square, ellipse, rectangle, or simple geometric shape.

10. The method according to claim 9 wherein the shape is a circle.

11. The method according to claim 9 wherein a smallest hole-to-hole distance is greater than or equal to twice a diameter of the holes.
